(19) United States
(12) Patent Application Publication
(10) Pub. No.: US 2015/0351194 A1
(43) Pub. Date: Dec. 3, 2015

(54) OLED Lighting Module and Lighting Apparatus and Interactive Light Wall Using the Same

(71) Applicant: Ultimate Image Corporation, Miaoli County (TW)

(72) Inventor: Chih-Feng Sung, Miaoli County (TW)

(21) Appl. No.: 14/704,904

(22) Filed: May 5, 2015

(30) Foreign Application Priority Data
May 5, 2014 (TW) 103116006

(51) Int. Cl. H05B 33/08; H05B 37/02

(52) U.S. Cl. CPC H05B 33/0896; H05B 37/0227

(57) ABSTRACT

The disclosure provides an OLED lighting module and a lighting apparatus and an interactive light wall using the same. The OLED lighting module has a sensing unit, a signal source filtering unit and an OLED unit. The sensing unit generates a sensing signal according to the environment status sensed by the sensing unit. The signal source filtering unit determines whether to provide an output assembly according to the sensing signal. The OLED unit activates lighting circuits corresponding to the received output assembly and a corresponding final color light is provided accordingly.

### FIELD OF THE INVENTION

The present invention relates to an application of organic light emitting diodes (OLEDs), and more particularly to an OLED lighting module and a lighting apparatus and an interactive light wall using the same.

### BACKGROUND OF THE INVENTION

Organic light emitting diodes (OLEDs) are self-illuminating, high in brightness, and suitable for production of display panels flatter than liquid crystal displays (LCDs). Therefore, OLEDs have gained increasingly strong attention from the industries. Among the current directions of technological development, OLEDs have been most commonly used in production of flexible flat display panels. In addition to display technologies, research and application of OLEDs have gradually shifted to lighting technologies in recent years due to its improving lighting efficiency. Taking advantage of its low driving voltage, high energy saving efficiency, fast reactivity, lightweight, low thickness, and simple structure, OLED has become the choice of lighting of the next generation. It is expected that OLED will take over the current mainstream lighting products.

However, due to its low production yield and high unit cost at early stages, extensive application of OLEDs on general lighting products has not been successful. Only by utilizing its diverse color emission and integrating it into intelligent lighting systems to increase its added value can advantages of OLED lighting products be accepted by the industries.

### SUMMARY OF THE INVENTION

Therefore, the present invention provides a creative alternative application of OLED technology.

An embodiment of the present invention provides an OLED lighting module comprised of a sensing unit, a signal source filtering unit, and an OLED unit. The signal sensing unit generates a sensing signal according to a sensed environmental status. The signal source filtering unit is electrically coupled to a plurality of color input sources and provides an output assembly, wherein each of the color input sources provides a color input signal with color light different from those provided by other color input sources; in addition, the signal source filtering unit receives the aforementioned sensing signal and determines whether to provide the output assembly according to the sensing signal. The OLED unit is comprised of a plurality of lighting circuits, each of which provides color light different from those provided by other lighting circuits when activated. The OLED unit is electrically coupled to the signal source filtering unit to receive the output assembly, and controls activation of each of the lighting circuits according to the output assembly, so as to provide a corresponding final color light.

Another embodiment of the present invention provides an OLED lighting apparatus comprised of a substrate and a plurality of OLED lighting modules. The OLED lighting modules are set on the substrate, and each of the OLED lighting modules are comprised of a signal sensing unit, a signal source filtering unit, and an OLED unit. The signal sensing unit generates a sensing signal according to the sensed environmental status. The signal source filtering unit is electrically coupled to a plurality of color input sources and provides an output assembly, wherein each of the color input sources provides a color input signal with color light different from those provided by other color input sources; in addition, the signal source filtering unit receives the aforementioned sensing signal and determines whether to provide the output assembly according to the sensing signal. The OLED unit is comprised of a plurality of lighting circuits, each of which provides color light different from those provided by other lighting circuits when activated. The OLED unit is electrically coupled to the signal source filtering unit to receive the output assembly, and controls activation of each of the lighting circuits according to the output assembly, so as to provide a corresponding final color light. Furthermore, the output assembly provided by the signal source filtering unit in each of the OLED lighting modules is comprised of at least of one of the color input sources in the signal source filtering unit, and all of the final color lights provided by the OLED lighting module are comprised of at least two colors.

Yet another embodiment of the present invention provides an interactive OLED color light wall, which is comprised of a plurality of OLED lighting apparatuses, each of which is comprised of a substrate and a plurality of OLED lighting modules. The OLED lighting modules are set on the substrate, and each of the OLED lighting modules is comprised of a signal sensing unit, a signal source filtering unit, and an OLED unit. The signal sensing unit generates a sensing signal according to the sensed environmental status. The signal source filtering unit is electrically coupled to a plurality of color input sources and provides an output assembly, wherein each of the color input sources provides a color input signal with color light different from those provided by other color input sources. The signal source filtering unit receives the sensing signal and determines whether to provide the output assembly according to the sensing signal. The OLED unit is comprised of a plurality of lighting circuits, each of which provides color light different from those provided by other lighting circuits when activated. The OLED unit is electrically coupled to the signal source filtering unit to receive the output assembly, and controls activation of each of the lighting circuits according to the output assembly, so as to provide a corresponding final color light. Furthermore, the final color light provided by the OLED lighting module in each of the OLED lighting apparatus comprises at least two colors.

As the present invention combines OLED with various types of sensors, providing interactions over the outside environment or human movements can be achieved. Additionally, since OLED is operable under a broad range of temperature and is easy to manufacture, the present invention can be extensively used in decorations of interior and exterior walls as well as window frames, on which the external patterns could alternate upon interacting with the surrounding environment, so as to achieve the beautification of the living environment.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is a circuit diagram of an interactive OLED color light wall of an embodiment of the present invention;

FIG. 2 is a circuit diagram of an OLED lighting apparatus of an embodiment of the present invention;

FIG. 3A is a circuit diagram of a signal source filtering unit of an embodiment of the present invention;

FIG. 3B is a circuit diagram of a signal source filtering unit of another embodiment of the present invention;

FIG. 3C is a circuit diagram of a signal source filtering unit of yet another embodiment of the present invention; and

FIG. 4 is a circuit diagram of an OLED unit of an embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

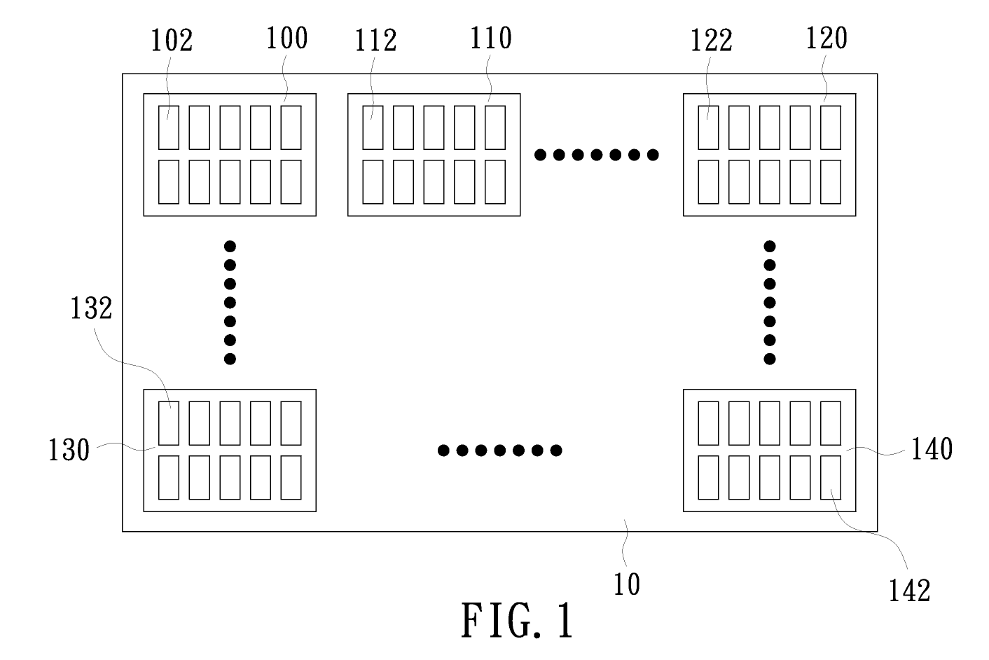

Referring now to FIG. 1, which illustrates the circuit structure of an interactive OLED color light wall of an embodiment of the present invention. In this embodiment, an interactive OLED color light wall 10 has a plurality of OLED lighting apparatuses, such as a plurality of OLED lighting apparatuses 100, 110, 120, 130, and 140. Each of the OLED lighting apparatuses provides a plurality of OLED lighting modules for lighting purposes. In this embodiment, the OLED lighting apparatus 100 provides a plurality of OLED lighting modules 102, the OLED lighting apparatus 110 provides a plurality of OLED lighting modules 112, the OLED lighting apparatus 120 provides a plurality of OLED lighting modules 122, the OLED lighting apparatus 130 provides a plurality of OLED lighting modules 132, and the OLED lighting apparatus 140 provides a plurality of OLED lighting modules 142.

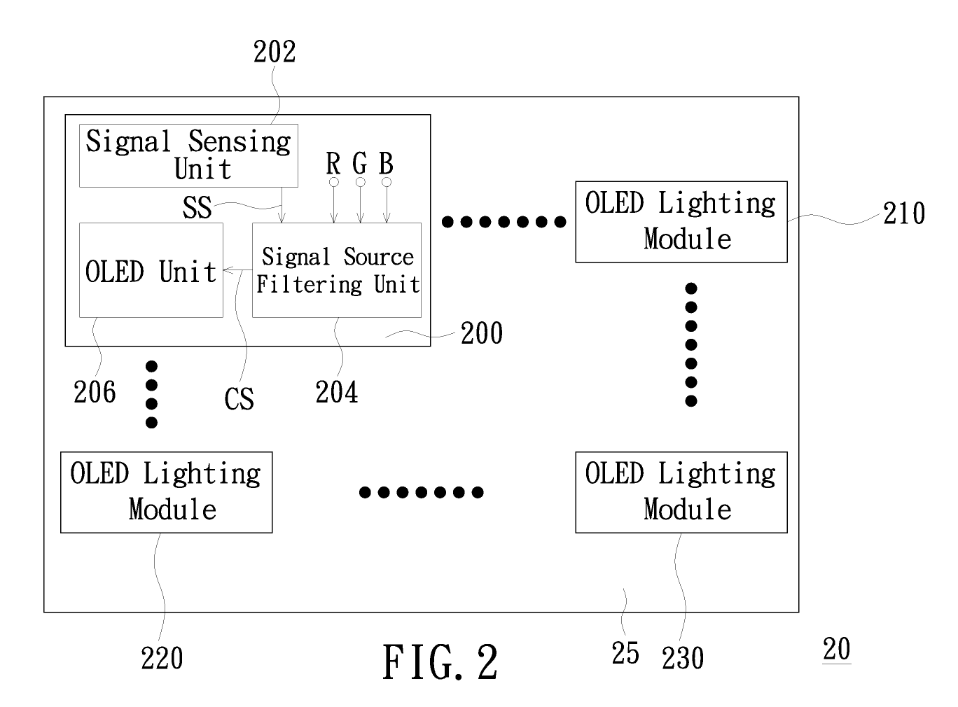

The following figures explain the circuit structures of each of the OLED lighting apparatus. Referring now to FIG. 2, which illustrates the circuit structure of an OLED lighting apparatus of an embodiment of the present invention. In this embodiment, an OLED lighting apparatus 20 has a plurality of OLED lighting modules, such as OLED lighting modules 200, 210, 220, and 230, each of which were set on a substrate 25. As circuit structures of each of the OLED lighting modules 200-230 are identical to each other, FIG. 2 illustrates only the detailed circuit structure of the OLED lighting module 200.

In the embodiment illustrated in FIG. 2, the OLED lighting module 200 has a signal sensing unit 202, a signal source filtering unit 204, and an OLED unit 206. Additionally, the OLED lighting module 200 can receive color input signals provided by color input sources R, G, and B; wherein the color represented by color input signals provided by the color input source R is primary red, the color represented by color input signals provided by the color input source G is primary green, and the color represented by color input signals provided by the color input source B is primary blue. As known by those with ordinary skill in the art, the color input signals provided by the color input sources are not necessarily the three primary colors. The colors mentioned herein are merely exemplary and are adjustable depending on specific needs arisen during implementation.

In this embodiment, the signal sensing unit 202 is adopted to sense the status of the outside environment. For example, the signal sensing unit 202 can sense the presence of any object around the signal sensing unit 202; that is, in other words, the signal sensing unit 202 is designed to detect the presence of any object in areas within the detectable range of the signal sensing unit 202. If no object were detected around the signal sensing unit 202, the signal sensing unit 202 would generate a sensing signal SS containing a first content; in contrast, if one or more objects were detected, the signal sensing unit 202 would generate a sensing signal SS containing a second content. To meet the operational requirements of the following circuits, the signal sensing unit 202 must generate the sensing signals SS with distinctive contents for presence and absence of objects; that is, the aforementioned first content must be distinguished from the second content. For example, the first content may be a low electric potential that lasts for a certain duration of time, while the second content being a high electric potential lasting for a certain duration of time; or, the first content may be a wave assembly representing the value of 0, while the second content being a wave assembly representing the value of 1. As a number of different content assemblies may be suitable for this operation, all possible examples are thus not provided herein.

Additionally, the signal sensing unit 202 may be comprised of signal sensing elements of any type. For example, image sensors, sound wave sensors, heat sensors, or pressure sensors may be chosen according to different requirements on sensing distances or subjects, so as to detect the current status of lighting, sound, temperature, or all sorts of pressure, respectively. Therefore, the sensing signals with different contents may be provided based on whether the distribution of light, volume of sound, or temperature of the environment or pressure administered to the environment meets the predetermined contents. Furthermore, the OLED lighting modules 200-230 may utilize signal sensing units comprised of the same signal sensing element. On the other hand, signal sensing elements not entirely identical to each other may also be used to comprise signal sensing units in different OLED lighting modules 200-230 for more diversified alterations.

The sensing signal SS generated by aforementioned signal sensing unit 202 would be provided to the signal source filtering unit 204, which is electrically coupled to the aforementioned color input sources R, G and B, and provides an output assembly CS to the OLIED unit 206. In this embodiment, signal source filtering unit 204 would determine whether to provide the output assembly CS to the OLED unit 206 according to the received sensing signal SS.

For those with ordinary skills in the art to gain a deeper understanding of the signal source filtering unit 204, illustrations will be referred to in the followings for more detailed descriptions on the signal source filtering unit 204.

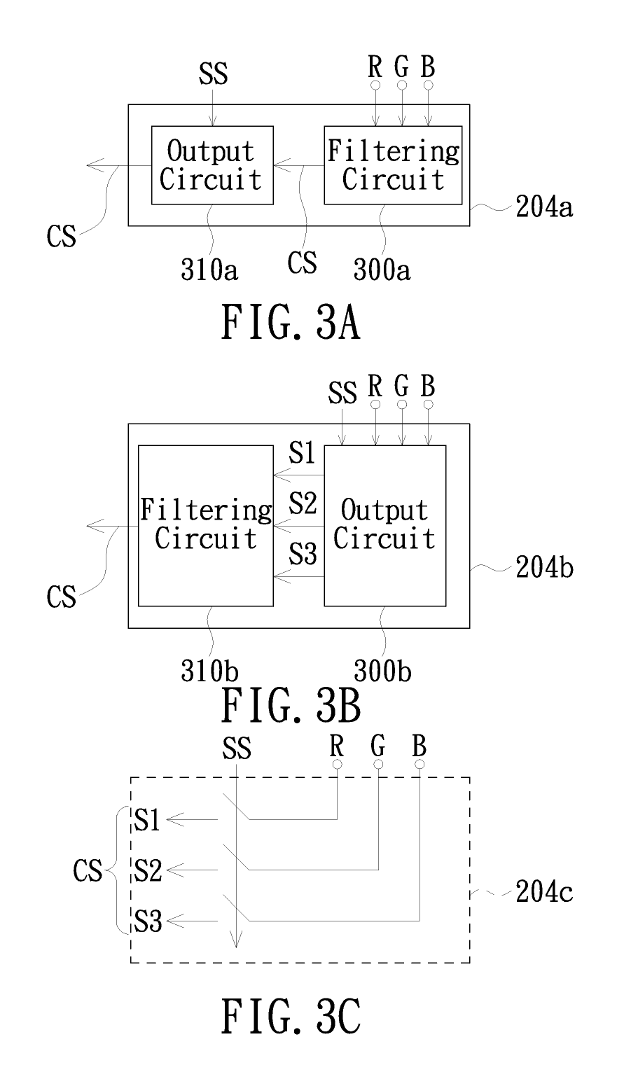

Referring now to FIG. 3A, which demonstrates the circuit structure of a signal source filtering unit of an embodiment of the present invention. As shown in FIG. 3A, a signal source filtering unit 204a has a filtering circuit 300a and an output circuit 310a. The filtering circuit 300a is electrically coupled to the color input sources R, G, and B, as shown in FIG. 2, and determines what to choose among color input signals provided by the color input sources R, G, and B, so as to integrate and output the aforementioned output assembly CS. However, the output circuit 310a is electrically coupled to the filtering circuit 300a for receiving the output assembly CS provided by the filtering circuit 300a. In addition, the output circuit 310a also receives the aforementioned sensing signal SS, and determines whether to provide the received output assembly CS to the OLED unit 206, as shown in FIG. 2, according to the sensing signal SS.

In another embodiment illustrated in FIG. 3B, which shows the circuit diagram of a signal source filtering unit of another embodiment of the present invention. A signal source filtering unit 204b processes under an algorithm different from that of a signal source filtering unit 204a. As shown in FIG. 3B, the signal source filtering unit 204b includes an output circuit 300a and a filtering circuit 310b. Different from the structure shown in FIG. 3A, the output circuit 300b is electrically coupled to the aforementioned color input sources R, G, and B to receive the color input signals provided by the color input sources R, G, and B. Furthermore, output circuit 300b receives aforementioned sensing signal SS and determines whether to output the received color input signal to the filtering circuit 310b according to the content of the sensing signal SS. In this embodiment, a plurality of color input signals S1, S2, and S3 output by the output circuit 300b correspond to the color input signals provided by color input sources R, G, and B, respectively. The filtering circuit 310b is electrically coupled to the output circuit 300b to receive the color input signals S1, S2, and S3, and determines what to choose among the color input signals S1, S2, and S3, so as to integrate and output the aforementioned output assembly CS.

In the two embodiments mentioned above, the mechanism through which color input signals S1, S2, and S3 are chosen to obtain output assembly CS may be implemented by software, hardware, or firmware; and the timing of judgment may be preset, determined by random numbers, or freely adjustable. For example, how each signal source filtering unit 204a or 204b must choose among the color input signals S1, S2, and S3 to obtain the output assembly CS may be determined by preset software according to a prerecorded table.

Referring now to FIG. 3C, which illustrates the circuit structure of a signal source filtering unit of yet another embodiment of the present invention. In a signal source filtering unit 204c, a switch is inserted between the color input source R and the circuit providing the color input signal S1, and activates according to the content of the sensing signal SS. Similarly, a switch is also inserted between the color input source G and the circuit providing the color input signal S2 and between the color input source B and the circuit providing the color input signal S3; and activation of the switches also depends on the content of the sensing signal SS. Note that the control of the sensing signal SS over every switch in the same signal source filtering unit 204c may be identical or different. For example, the sensing signals SS with the same content may activate the switch between the color input source R and the circuit providing color input signal S1, deactivate the switch between the color input source G and the circuit providing color input signal S2, and meanwhile be non-responsible for controlling of the activation of the switch between the color input source B and the circuit providing color input signal S3. As a result, the content integrated from the color input signals S1, S2, and S3 becomes the output assembly CS provided by the signal source filtering unit 204c.

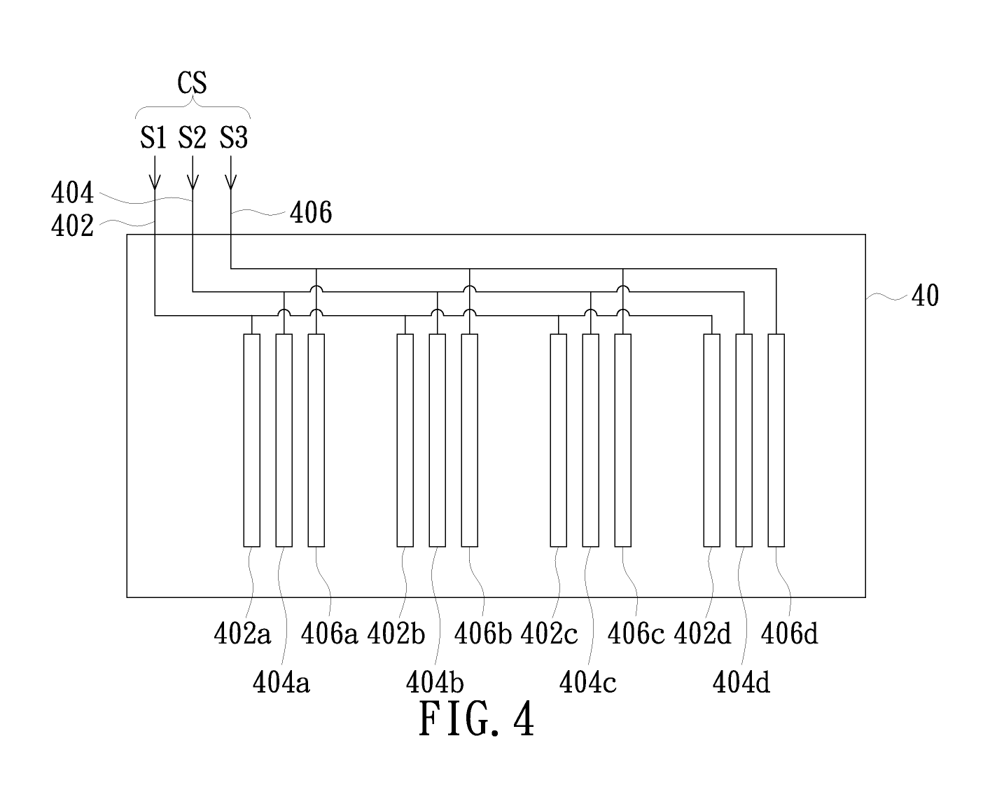

Referring again to FIG. 2, the output assembly CS provided by the signal source filtering unit 204 is received by an OLED unit 206, which lights according the received output assembly CS. In general, an OLED unit is comprised of a plurality of lighting circuits. Referring now to FIG. 4, which illustrates the circuit structure of an OLED unit of an embodiment of the present invention. In this embodiment, an OLED unit 40 is electrically coupled to the aforementioned signal source filtering unit to receive the output assembly CS, including the color input signals S1, S2, and S3; and is comprised of driver circuits 402, 404, and 406 and lighting blocks 402a-402d, 404a-404d, and 406a-406d. A lighting circuit of OLED unit 40 is comprised of a driver circuit 402 and a plurality of lighting blocks 402a-402d controlled and driven by color input signal S1 transmitted via the driver circuit 402; another lighting circuit of OLED unit 40 is comprised of a driver circuit 404 and a plurality of lighting blocks 404a-404d controlled and driven by color input signal S2 transmitted via the driver circuit 404; and a third lighting circuit of OLED unit 40 is comprised of a driver circuit 406 and a plurality of lighting blocks 406a-406d controlled and driven by color input signal S3 transmitted via the driver circuit 406. Referring to general principals of light emission, this embodiment is designed to emit red light when lighting blocks 402a, 402b, 402c, and 402d are driven, emit green light when lighting blocks 404a, 404b, 404c, and 404d are driven, and emit blue light when lighting blocks 406a, 406b, 406c, and 406d are driven. In this way, OLED unit 40 is enabled to control activation of each of the aforementioned lighting circuits according to the received output assembly CS, and provide a final color light according to the color assembly of the emitted color lights.

To increase the diversity of color emission in actual implementation, OLED units in each OLED lighting module can be designed to provide final color lights that are not entirely identical to each other; that is, at least two final color lights can be designed to provide by a plurality of OLED units in the OLED lighting modules. For example, in an OLED lighting module, some OLED units can be designed to emit a final red, some emits a final purple (red+blue), while some emits a final light blue (blue+green).

Moreover, for energy conversation purposes, sensing signals generated by the signal sensing unit can be encoded to deactivate the corresponding OLED unit when the sensed environmental status is in default; on the contrary, when the environment sensed by the signal sensing unit is not in a default status, the generated sensing signals can be encoded to allow the corresponding signal source filtering unit to provide the aforementioned output assembly, so as to activate the corresponding OLED unit and thus provide a corresponding final color light for a certain duration of time. However, if considering from a decoration or lighting perspective, sensing signals generated by the signal sensing unit can be encoded to let the corresponding OLED unit provide a final white light when the sensed environmental status is in default; and allow the OLED unit to provide a corresponding final color light other than white when the environment sensed by the signal sensing unit is not in a default status.

In summary, the aforementioned embodiments combine OLED with various types of sensors, providing interactions over the outside environment or human movements. Additionally, since OLED is operable under a broad range of temperature and is easy to manufacture, the present invention can be extensively used in decorations of interior and exterior walls as well as window frames, on which the external patterns could alternate upon interacting with the surrounding environment, so as to achieve the beautification of the living environment.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An OLED lighting apparatus, comprising:
a substrate; and
a plurality of OLED lighting modules, set on said substrate, each of said OLED lighting modules comprising:
a signal sensing unit, generating a sensing signal according to an environmental status sensed by said signal sensing unit;
a signal source filtering unit, electrically coupling to a plurality of color input sources and providing an output assembly, wherein each of said color input sources provides a color input signal with color light different from those provided by other said color input sources, and said signal source filtering unit receiving said sensing signal and determines whether to provide said output assembly according to said sensing signal; and
an OLED unit, comprising a plurality of lighting circuits, each of said lighting circuits providing color light different from those provided by other said lighting circuits when activated, said OLED unit electrically coupling to said signal source filtering unit in order to receive said output assembly, and controlling activation of each of said lighting circuits according to said output assembly in order to provide a corresponding final color light;
wherein said output assembly provided by said signal source filtering unit in each of said OLED lighting modules is comprised of at least of one of said color input sources in said signal source filtering unit, and said final color light provided by said OLED lighting module are comprised of at least two colors.

2. The OLED lighting apparatus according to claim 1, wherein said signal source filtering unit comprises:
a filtering circuit, electrically coupling to said color input sources and determining which of said color input signals to integrate, so as to output said output assembly; and
an output circuit, receiving said sensing signal and electrically coupling to said filtering circuit in order to receive said output assembly, said output circuit determining whether to provide said output assembly according to said sensing signal.

3. The OLED lighting apparatus according to claim 1, wherein said signal source filtering unit comprises:
an output circuit, receiving said sensing signal and electrically coupling to said color output sources, said output circuit determining whether to output said color input signals received by said color output sources; and
a filtering circuit, electrically coupling to said output circuit in order to receive said color output signals output by said output circuit and determining which of said color input signals to integrate, so as to output said output assembly.

4. An OLED lighting module, comprising:
a signal sensing unit, generating a sensing signal according to an environmental status sensed by said signal sensing unit;
a signal source filtering unit, electrically coupling to a plurality of color input sources and providing an output assembly, wherein each of said color input sources provides a color input signal with color light different from those provided by other said color input sources, and said signal source filtering unit receiving said sensing signal and determines whether to provide said output assembly according to said sensing signal; and
an OLED unit, comprising a plurality of lighting circuits, each of said lighting circuits providing color light different from those provided by other said lighting circuits when activated, said OLED unit electrically coupling to said signal source filtering unit in order to receive said output assembly, and controlling activation of each of said lighting circuits according to said output assembly in order to provide a corresponding final color light.

5. The OLED lighting module according to claim 4, wherein said signal source filtering unit comprises:
a filtering circuit, electrically coupling to said color input sources and determining which of said color input signals to integrate, so as to output said output assembly; and
an output circuit, receiving said sensing signal and electrically coupling to said filtering circuit in order to receive said output assembly, said output circuit determining whether to provide said output assembly according to said sensing signal.

6. The OLED lighting module according to claim 4, wherein said signal source filtering unit comprises:
an output circuit, receiving said sensing signal and electrically coupling to said color output sources, said output circuit determining whether to output said color input signals received by said color output sources; and
a filtering circuit, electrically coupling to said output circuit in order to receive said color output signals output by said output circuit and determining which of said color input signals to integrate, so as to output said output assembly.

7. An interactive OLED color light wall, comprising:
a plurality of OLED lighting apparatuses, each of said OLED lighting apparatuses comprising:
a substrate; and
a plurality of OLED lighting modules, set on said substrate, each of said OLED lighting modules comprising:
a signal sensing unit, generating a sensing signal according to an environmental status sensed by said signal sensing unit;
a signal source filtering unit, electrically coupling to a plurality of color input sources and providing an output assembly, wherein each of said color input sources provides a color input signal with color light different from those provided by other said color input sources, and said signal source filtering unit receiving said sensing signal and determines whether to provide said output assembly according to said sensing signal; and
an OLED unit, comprising a plurality of lighting circuits, each of said lighting circuits providing color light different from those provided by other said lighting circuits when activated, said OLED unit electrically coupling to said signal source filtering unit in order to receive said output assembly, and controlling activation of each of said lighting circuits according to said output assembly in order to provide a corresponding final color light;
wherein said output assembly provided by said signal source filtering unit in each of said OLED lighting modules is comprised of at least of one of said color input sources in said signal source filtering unit, and said final color light provided by said OLED lighting module are comprised of at least two colors.

8. The interactive OLED color light wall according to claim 7, wherein said signal source filtering unit comprises:
a filtering circuit, electrically coupling to said color input sources and determining which of said color input signals to integrate, so as to output said output assembly; and
an output circuit, receiving said sensing signal and electrically coupling to said filtering circuit in order to receive said output assembly, said output circuit determining whether to provide said output assembly according to said sensing signal.

9. The interactive OLED color light wall according to claim 7, wherein said signal source filtering unit comprises:
an output circuit, receiving said sensing signal and electrically coupling to said color output sources, said output circuit determining whether to output said color input signals received by said color output sources; and
a filtering circuit, electrically coupling to said output circuit in order to receive said color output signals output by said output circuit and determining which of said color input signals to integrate, so as to output said output assembly.

10. The interactive OLED color light wall according to claim 7, wherein said final color light provided by said OLED unit according to said sensing signal when no object is present around said sensing unit is white.

11. The interactive OLED color light wall according to claim 7, wherein said sensing signal generated by said sensing unit deactivates said OLED unit when no object is present around said sensing unit.
